(19) United States
(12) Patent Application Publication
(10) Pub. No.: US 2022/0180326 A1
(43) Pub. Date: Jun. 9, 2022

(54) SYSTEM AND METHOD FOR AUTOMATICALLY DETERMINING A COMPATIBILITY QUALITY SCORE FOR SELECTING A SUITABLE CANDIDATE FOR A JOB ROLE

(71) Applicant: Jobs and Talent S.L., Madrid (ES)

(72) Inventors: Michele Trevisiol, Madrid (ES); Andres Garcia-Poveda, Madrid (ES); Joaquin Perez-Iglesias, Madrid (ES); Jose Gabriel Martinez-Martin, Madrid (ES); Francisco Javier Fortea, Madrid (ES); Alvaro de Prada Martinez, Madrid (ES)

(21) Appl. No.: 17/682,267

(22) Filed: Feb. 28, 2022

Related U.S. Application Data
(62) Division of application No. 16/905,860, filed on Jun. 18, 2020.

(51) Int. Cl. G06Q 10/10; G06Q 10/06

(52) U.S. Cl. CPC G06Q 10/1053; G06Q 10/063112; G06Q 10/06398

(57) ABSTRACT

There is provided a method of automatically determining a compatibility quality score for selecting at least one candidate from a plurality of candidates suitable for a job role, using a machine learning model, characterized in that the method comprising: receiving a candidate information via a communication device of at least one candidate, wherein the candidate information comprises at least one of personal information, an information regarding a specific job assignment, or an input associated with a recruitment process, associated with the at least one candidate; and automatically determining, a compatibility quality score for the candidate based on the candidate information and a set of variables, for each of the plurality of candidates for the job role, and wherein the compatibility quality score is determined by applying a hypothesis through at least one mathematical predictor from among a plurality of mathematical predictors.

### TECHNICAL FIELD

The present disclosure relates generally to a system and method for automatically determining a compatibility quality score for selecting a suitable candidate for a job role. Moreover, the aforesaid system, when in operation, receives candidate information via a communication device, automatically determines a compatibility quality score for the candidate using a machine learning model and automatically selects at least one candidate with the highest competence and suitability for the job role.

### BACKGROUND

Recruitment is a process of finding candidates, reviewing applicant credentials, screening potential employees, and selecting employees for an organization. Effective recruitment results in an organization hiring employees who are skilled, experienced, and good fits with corporate culture. Recruitment methods should ensure the selection of engaged, competent, productive employees who are loyal to the organization. A recruiter may select the best candidate or create a pool of best candidates that would do well for an institution or firm. Several known methods available to select a suitable candidate for a suitable role, includes, for example, application forms and curriculum vitae, online screening and shortlisting, interviews, psychometric testing, ability and aptitude tests, personality profiling, presentations, group exercises, assessment centers or references and the like. Several new techniques for selecting the suitable candidate are emerging in the market day by day.

In job roles such as, for example, production line workers, manual labourers, assembly workers, construction workers as well as delivery drivers, builders, cleaners, the job roles are characterised by high safety standards and require specific competencies for providing the right quality and production rate. These job roles are also characterised by a high no show rate, varying quality of performance. In the above mentioned scenarios, it is even more important to find and assign candidates who will be competent and diligent workers, by finding the most compatible worker, having the highest competence and suitability for the assignment, to reduce the impact of the human error, thereby affecting the assembly or production line in large, providing a higher safety standard and a higher production rate and/or quality.

In general, for any type of production line or assembly work, the quality and safety standards are most affected by the human factor, whereby most errors and/or accidents occur due to the human factor.

Existing recruitment tools and techniques do not enable automatic selection of candidates for a job role based on their abilities, competencies, suitability, and performances, that are suitable for the job role.

Therefore, there arises a need to address the aforementioned technical drawbacks in existing technologies in selecting a suitable candidate for the job role.

### SUMMARY

The present disclosure seeks to provide an improved system and method that, when in operation, automatically determines a compatibility quality score for selecting at least one suitable candidate from a plurality of candidates for a job role.

According to a first aspect, there is provided a method of automatically determining a compatibility quality score for selecting at least one candidate from among a plurality of candidates suitable for a job role, using a machine learning model, to ensure a high production rate and to maintain safety standards, the method comprising:

receiving a candidate information via a communication device of at least one candidate, wherein the candidate information comprises at least one of personal information, an information regarding a specific job assignment, or an input associated with a recruitment process, associated with the at least one candidate; and

automatically determining a compatibility quality score for the candidate based on the candidate information and a set of variables, for each of the plurality of candidates for selecting the at least one candidate suitable for the job role, and wherein the compatibility quality score is determined by applying a hypothesis through at least one mathematical predictor from among a plurality of mathematical predictors.

Optionally, the method further comprises automatically selecting the at least one candidate from among the plurality of candidates with a highest competence and suitability for the job role based on the compatibility quality score, thereby reducing an impact of the human error affecting a production line in large and enabling achievement of a higher safety standard and a higher production rate and quality.

Optionally, the set of variables comprises at least one of:

variables associated with one or more historical assignments;

a behaviour of the candidate within an application during a recruitment process;

personal information of the candidate; or

external data.

Optionally, the compatibility quality score reflects at least one of an ability of the candidate to perform the job role, one or more competencies, a suitability of the candidate for the job role, a performance of the candidate in the job role, or a social and behavioural parameter associated with the at least one candidate.

Optionally, the selection of the at least one candidate is performed using a matching framework. The matching framework is configured to determine non-linear relationships among the variables in the set of variables, and wherein the matching framework is configured to optimize contract completion.

Optionally, the matching framework is based on machine learning.

Optionally, applying the hypothesis based on the at least one mathematical predictor comprises:

dynamically generating at least one cluster of candidates working on one or more similar assignments;

comparing and evaluating the at least one cluster of candidates;

applying a simple hypothesis corresponding to each of the set of variables as a proxy for each of the at least one cluster of candidates through the plurality of mathematical predictors, and combining an outcome of each of the plurality of mathematical predictors to generate a combined hypothesis;

aggregating the combined hypothesis corresponding to each of the at least one cluster of candidates as a weighted average with a dynamic weighting, to remove bias, wherein the hypothesis that is associated with a lowest significance in the particular cluster is given a lower weight, wherein the aggregation enables maximizing of information that are extracted from a complete set;

evaluating the combined hypothesis by comparing a result of the combined hypothesis with a predetermined feedback to generate an evaluated hypothesis; and

combining the evaluated hypothesis with one or more previously evaluated hypothesis and evaluating an outcome of the results with one or more meaningful workforce outcomes.

Optionally, the one or more similar assignments comprise assignments from a common employer, assignments from the common employer on a common site, and assignments from the common employer on the common site and on a common shift, depending on a volume of data available at a given time.

Optionally, the hypothesis that carry more significance in a particular cluster is given a higher weight.

Optionally, the compatibility quality score is a weighted average of the aggregated scores generated from the plurality of mathematical predictors applied to different hypothesis.

Optionally, the method comprises applying the plurality of mathematical predictors to each hypothesis.

Optionally, the plurality of mathematical predictors comprises at least one of: a Quantile-based scoring system, a Uniform-separation scoring system or a Clustering-based scoring system.

Optionally, the compatibility quality score is a weighted average of the aggregated compatibility quality scores determined using the plurality of mathematical predictors applied to a plurality of hypothesis.

Optionally, the compatibility quality score is determined based on an employment data of the candidate from one or more other job functions and a plurality of predicted data points for a function that the candidate is not experienced with.

Optionally, the compatibility quality score is calculated for completely new candidates based on a plurality of predicted data points.

Optionally, the set of variables comprises at least one online variable associated with the candidate.

Optionally, the compatibility quality score is analysed among workers for at least one of a same company, a job-function or a common province to reduce context bias.

Optionally, the compatibility quality score is calculated based on at least one of an employment data or the hypothesis that is made on the employment data using a decision tree model.

According to a second aspect, there is provided a system for automatically determining a compatibility quality score for selecting at least one candidate from among a plurality of candidates suitable for a job role, using a machine learning model, to ensure a high production rate and to maintain safety standards, the system comprising:

a memory that stores a set of instructions and an information associated with a machine learning algorithm;

a processor that executes the set of instructions via a plurality of modules, for performing the steps comprising:
a candidate information receiving module implemented by the processor and configured to receive a candidate information via a communication device of at least one candidate, wherein the candidate information comprises at least one of personal information, an information regarding a specific job assignment, or an input associated with a recruitment process, associated with the at least one candidate; and
a compatibility quality score determining module implemented by the processor and configured to automatically determine, a compatibility quality score for the candidate based on the candidate information and a set of variables, for each of the plurality of candidates for the job role, and wherein the compatibility quality score is determined by applying a hypothesis through at least one mathematical predictor from among a plurality of mathematical predictors.

Optionally, the system further comprises a candidate selecting module that is implemented by the processor and configured to automatically select the at least one candidate from among the plurality of candidates with highest competence and suitability for the job role based on the compatibility quality score, thereby enabling achievement of a higher safety standard and a higher production rate and quality.

Optionally, the set of variables comprises at least one of:

variables associated with one or more historical assignments;

a behaviour of the candidate within an application during a recruitment process;

personal information of the candidate; or

external data received from one or more clients.

Optionally, applying the hypothesis based on the at least one mathematical predictor comprises:

dynamically generating at least one cluster of candidates working on one or more similar assignments;

comparing and evaluating the at least one cluster of candidates, wherein the one or more similar assignments comprises assignments from a common employer, assignments from the common employer on a common site, and assignments from the common employer on the common site and on a common shift, depending on a volume of data available at a given time;

applying a simple hypothesis corresponding to each of the predefined set of variables as a proxy for each of the at least one cluster of candidates through the plurality of mathematical predictors, and combining an outcome of each of the plurality of mathematical predictors to generate a combined hypothesis, wherein the plurality of mathematical predictors comprises at least one of a Quantile-based scoring system, a Uniform-separation scoring system and a Clustering-based scoring system;

aggregating the combined hypothesis corresponding to each of the at least one cluster of candidates as a weighted average with a dynamic weighting, to remove bias, wherein the hypothesis that is associated with a highest significance in a particular cluster is given a higher weight, wherein the hypothesis that is associated with a lowest significance in the particular cluster is given a lower weight, and wherein the aggregation enables maximizing of information that are extracted from a complete set;

evaluating the combined hypothesis by comparing a result of the combined hypothesis with a predetermined feedback to generate an evaluated hypothesis; and

combining the evaluated hypothesis with one or more previously evaluated hypothesis and evaluating an outcome of the results with one or more meaningful workforce outcomes.

According to a third aspect, there is provided a computer program product comprising instructions to cause the system of the first aspect to carry out the method of the second aspect.

It will be appreciated that the aforesaid present method is not merely a “method of automatically selecting a suitable candidate for a job role” as such, “software for a computer, as such”, “methods of doing a mental act, as such”, but has a technical effect in that the method receives a candidate information via a communication device, automatically determines a compatibility quality score for the candidate using a machine learning model and automatically selects at least one candidate with a highest competence and suitability for the job role. The method of automatically selecting the candidate for the job role involves building an artificially intelligent machine learning model and/or using the artificially intelligent machine learning model to address, for example, to solve, the technical problem of determining the compatibility quality score for each of the plurality of candidates and automatically selecting the at least one candidate with highest competence and suitability for the job role based on the compatibility quality score by applying a hypothesis through a mathematical predictor.

Further, compensating at least one element of the system that automatically determines the compatibility quality score for the candidate optionally causes a hardware reconfiguration of the system, for example selectively switches in additional processor capacity and/or more data memory capacity and/or different types of graphic processor chip, and the hardware reconfiguration or hardware status is regarded as being technical in nature. Thus, to consider the method of the present disclosure to be the subject matter that is excluded from patentability would be totally inconsistent with UK practice in respect of inventions that are technically closely related to embodiments described in the present disclosure.

Embodiments of the present disclosure substantially eliminate or at least partially address the aforementioned technical drawbacks in existing technologies in determining the compatibility quality score for selecting the at least one candidate for the job role by finding the most compatible candidate having the highest competence and suitability for the job role. The system reduces an impact of the human error affecting a production line, and enables providing a higher safety standard and a higher production rate and/or quality.

Additional aspects, advantages, features, and objects of the present disclosure are made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system in accordance with an embodiment of the present disclosure;

FIG. 2 is a functional block diagram of a system in accordance with an embodiment of the present disclosure;

FIG. 3 is a flowchart illustrating a process flow for applying hypothesis based on at least one mathematical predictor using a system in accordance with an embodiment of the present disclosure;

FIGS. 4A-4C are user interface views of a system, in accordance with an embodiment of the present disclosure;

FIGS. 5A-5D illustrate graphs that depict a quality score of each of a plurality of candidates, in accordance with an embodiment of the present disclosure;

FIG. 6 is a flowchart illustrating steps of a method for (of) automatically determining a compatibility quality score for selecting at least one candidate from among a plurality of candidates suitable for a job role, in accordance with an embodiment of the present disclosure; and

FIG. 7 is an illustration of an exploded view of a computing architecture/system in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

According to a first aspect, there is provided a method of automatically determining a compatibility quality score for selecting at least one candidate from among a plurality of candidates suitable for a job role, using a machine learning model, to ensure a high production rate and to maintain safety standards, the method comprising:

receiving a candidate information via a communication device of at least one candidate, wherein the candidate information comprises at least one of personal information, an information regarding a specific job assignment, or an input associated with a recruitment process, associated with the at least one candidate; and

automatically determining, the compatibility quality score for the candidate based on the candidate information and a set of variables, for each of the plurality of candidates for the job role, and wherein the compatibility quality score is determined by applying a hypothesis through at least one mathematical predictor from among a plurality of mathematical predictors.

The present method improves and automates the determination of the compatibility quality score for each of the plurality of candidates and the selection of a suitable candidate from the plurality of candidates for the job role based on the candidate information received via the communication device in real-time. In an embodiment, the present method employs a server to communicate with the communication device associated with the at least one candidate through a network. In an embodiment, the communication device is selected from at least one of a mobile phone, a kindle, PDA (Personal Digital Assistant), a tablet, a computer, an electronic notebook or a smartphone. In an embodiment, the network is a wired network. In another embodiment, the network is a wireless network. In yet another embodiment, the network is a combination of the wired network and the wireless network. In yet another embodiment, the network is the Internet. In an embodiment, the server is optionally a tablet, a desktop, a personal computer or an electronic notebook. In an embodiment, the server is optionally a cloud service. In an embodiment, the present method is implemented in a software or a hardware or a combination thereof.

In an embodiment, the candidate information comprises at least one of a personal information, an information regarding a specific job assignment, or an input associated with a recruitment process, associated with the at least one candidate. In an embodiment, the at least one candidate may provide the personal information. The personal information comprises at least one of, but not limited to, full name, birth date, age, gender, email Id, short bio, country, pin code, province, contact number, Facebook details or linked in details of each of the plurality of candidates.

The present method may train the machine learning model with the candidate information of each candidate for the job role. In an embodiment, the present method analyzes the candidate information received from the communication device and a set of variables using the machine learning model to determine the compatibility quality score for the candidate of each of the plurality of candidates for the job role. In an embodiment, the compatibility quality score reflects at least one of an ability of the candidate to perform the job role, one or more competencies, a suitability of the candidate for the job role, a performance of the candidate in the job role, or a social and behavioural parameter associated with the at least one candidate. The compatibility quality score is determined by applying a hypothesis through at least one mathematical predictor from among a plurality of mathematical predictors.

In an embodiment, the compatibility quality score comprises predictors, that relate to the affinity of each of the plurality of candidates comprising, but not limited to, a home/work traveling distance, a difference between the salary offered and the average salary of the candidate and so on. In an embodiment, the predictors analyze the distribution by comparing the values among the each of the plurality of candidates of the same company/firm and job function to find a suitable candidate and a worst candidate.

The present method automatically selects the at least one candidate from among the plurality of candidates with a highest competence and suitability for the job role based on the compatibility quality score, thereby enabling achievement of a higher safety standard and a higher production rate and quality.

In an embodiment, the compatibility quality score is determined using a formula as follows:

$$Quality Score = \frac{{\sum }_{i = 1}^{n} {w}_{i} {x}_{i}}{{\sum }_{i = 1}^{n} {w}_{i}} = \frac{{w}_{1} * {score}_{1} + {w}_{2} * {score}_{2} + … + {w}_{n} * {score}_{n}}{{w}_{1} + {w}_{2} + … + {w}_{n}} ,$$

where w is a weighted average of the scores calculated.

In an embodiment, the scores are determined from the different hypothesis using the different mathematical predictors.

In an embodiment, the present method ranks suitable candidates from the plurality of candidates to predict a most suitable candidate for the job role using a candidate ranker algorithm based on the candidate information. The candidate ranker algorithm is trained with historical data that comprises one or more recruitment processes and a finalized contract information of the plurality of candidates. In an embodiment, the historical data generates a relevance between the plurality of candidates and the job role. The relevance comprises how far the each of the plurality of candidates is on a recruitment funnel, and a performance of each of the plurality of candidates during the contract. The present method predicts a plurality of suitable candidates using a regression algorithm. In an embodiment, the regression algorithm predicts a number of suitable candidates to be in order from the plurality of suitable candidates to fulfill the required job role in the vacancy.

In an embodiment, the present method ranks the suitable candidates from the plurality of candidates for the job role using the candidate ranker algorithm based on the set of variables. In an embodiment, the set of variables comprises at least one of: (i) variables associated with one or more historical assignments, (ii) a behaviour of the candidate within an application during a recruitment process; (iii) personal information of the candidate; or (iv) external data.

In an embodiment, the set of variables are calculated from the history of the candidate which are “offline” variables that are precalculated from past information. In an embodiment, the set of variables is calculated from a specific candidate or vacancy match of the at least one candidate which are “online” or “live” variables calculated in real-time.

In an embodiment, the present method automatically selects the suitable candidate for the job role based on the determined compatibility quality score using the machine learning model.

In an embodiment, the compatibility quality score comprises a worker quality score, a job-function quality score and a cold-start worker quality score.

In an embodiment, the present method determines the worker quality score from internal data points. The internal data points comprise at least one of contracts, salary, attendance, mobile behaviours or interview process behaviors of each of the plurality of candidates. The worker quality score is a numerical summary of a quality of a candidate in a specific job function that is evaluated by the assignments. In an embodiment, the present method determines the worker quality score of the candidate for every 3 hours. In an embodiment, the hypothesis is a proxy for the quality of the candidate. In an embodiment, if the hypothesis is insufficient and inaccurate on an individual level of determining the worker quality score for the plurality of candidates, the present method evaluates the hypothesis as indicators of quality. In an embodiment, the indicators comprise an attrition indicator that is calculated. In an example embodiment, the attrition indicator considers a different approach of positive and negative reasons for the cancelled contracts.

In an embodiment, the present method evaluates the hypothesis by comparing results with other feedbacks and combines the hypothesis to evaluate an outcome of the results with workforce outcomes. In an embodiment, a combination of a series of hypothesis reduces inaccuracy, lack of data and biases. In an embodiment, the present method reduces the inaccuracy, the lack of data and the biases by (i) evaluating and comparing candidates in similar assignments, (ii) applying each hypothesis through three different mathematical predictors and then combining the hypothesis, and (iii) aggregating the hypothesis as a weighted average with dynamic weighting along with the similar assignments. In an embodiment, the similar assignment comprises (i) candidates working in the same institution/firm, or (ii) candidates working in the same institution/firm, on the same site, and on the same shift. In an embodiment, the hypotheses carry a higher significance in a particular cluster associated with a higher weight.

In yet another embodiment, the worker quality score comprises historical assignments, recruitment processes, social and behavioral and basic information of each of the plurality of candidates. In an embodiment, the historical assignments comprise, but not limited to, cancellations, extensions and renewals of the assignments. In an embodiment, the recruitment processes comprise, but not limited to, interview show up, training feedback, document uploads of each of the plurality of candidates. In an embodiment, the social and behavioral information comprises, but not limited to, candidate study and questionnaires. In an embodiment, the basic information comprises, but not limited to, demographics that include age, gender and nationality, profile completeness and document analysis of each of the plurality of candidates.

In an embodiment, the present method determines the job-function worker quality score for fresh candidates without job experience. In an embodiment, the job-function worker quality score is computed based on a prediction method using the machine learning model. In an embodiment, the job-function worker quality score is predicted by each candidate information from the plurality of candidates.

In an embodiment, the present method determines the cold-start worker quality score that estimates a future worker quality score of each of the plurality of candidates. In an embodiment, the cold-start worker quality score estimates the worker quality score when at least one of the plurality of candidates is a new candidate having any employment data. In an embodiment, the present method predicts the cold-start worker quality score based on the candidate information before employment, using the worker quality score as the ground truth. In an embodiment, the present method uses the machine learning model to use, but not limited to, candidates with assignment history, pre-employment data and the worker quality score to evaluate correlations. The correlations apply to, but not limited to, the candidates with no assignments and only with pre-employment data to calculate their worker quality score in a similar assignment. In an embodiment, the cold-start worker quality score comprises data categories that includes a social demography, In-app behavior and screening. In an embodiment, the social demography comprises, but not limited to, age and gender. In an embodiment, the In-app behavior comprises, but not limited to, job applications, job opening reading time, profile completeness and answer rate to notifications. In an embodiment, the screening comprises, but not limited to, role experience, type of experience, tests and interview questions.

In yet another embodiment, the worker quality score comprises basic data, recruitment data, assignments, attendance/timesheets, and response rate/reliability of each of the plurality of candidates.

In an embodiment, the basic data is the data provided by the candidate at the time of registration. In an embodiment, the basic data comprises at least one of, but not limited to, a full name, a birth date, an age, a gender, gender provided, an email, a year at which created, years since created, about me, short bio, country, pincode, province, a phone number, Facebook details or Linked-in details of each of the plurality of candidates. In an embodiment, the writing structure of the short biodata comprises some statistics that include a number of terms used, usage of punctuations, using always upper/lower case and sentiment analysis.

In an embodiment, the recruitment data is aggregated statistics about the performances of each of the plurality of candidates and their activity, documents uploaded, a timing between interview phases and so on. In an embodiment, the recruitment data comprises at least one of, but not limited to, average interviews, bad rejections, lead days, prospect days, ranking, interview source, interviews participated, success recruitment processes, or total hiring. In yet another embodiment, the recruitment data comprises eventify data that includes user behavior to review the job, a time to upload a document, number of photos made per document and the like.

In an embodiment, the assignments include aggregated information about the assignments that include original/real duration of the assignments, extra hours and so on. In an embodiment, the relative coverage of the assignments is a strong indicator of reliability and it focusses on cancellations and renewals of the assignments. In an embodiment, the assignments comprise, but not limited to, a candidate ID, a job function, a company group, a number of assignments, canceled assignments, assignments canceled by a company, assignments canceled by the candidate, assignments canceled by others, positive cancelations, negative cancelations, unemployed days, re-utilizations, a total assignment length, an average assignment length, an expected total assignment length, an expected average assignment length, a covered assignment, an average covered assignment, an average gross, an expected average gross, an estimated monthly average gross and an estimated yearly average gross.

In an embodiment, the attendance/timesheets are an account for no shows, late arrival and earlier leaving of each of the plurality of candidates. In an embodiment, the attendance/timesheets comprise a shift absence rate, a shift acceptance rate, a shift attendance rate, total absence hours, total absented hours, total accepted hours, total accepted shifts, total attended hours, total attended shifts, total rejected hours, total rejected shifts, total scheduled hours, total scheduled shifts, total weeks, average absence hours per week, average absence shifts per week, average accepted hours per week, average accepted shifts per week, average attended shifts per week, average attended hours per week, average hours to answer shift, average rejected hours per week, average rejected shifts per week, average scheduled hours per week, and average scheduled shifts per week.

In an embodiment, the response rate/reliability is a behavioral data that infers the day-to-day quality of the candidate with great accuracy.

According to an embodiment, the method further comprises automatically selecting the at least one candidate from among the plurality of candidates with a highest competence and suitability for the job role based on the compatibility quality score, thereby enabling achievement of a higher safety standard and a higher production rate and quality.

According to another embodiment, the set of variables comprises at least one of:

a) variables associated with one or more historical assignments;

b) a behaviour of the candidate within an application during a recruitment process;

c) personal information of the candidate; or

d) external data.

In an embodiment, the personal information comprises at least one of, but not limited to, full name, birth date, age, gender, email Id, short bio, country, pin code, province, contact number, Facebook details or linked in details of the candidate. In an embodiment, the present method receives the external data from one or more clients or any other database. In an embodiment, the external data comprises at least one of, but not limited to, age, gender and nationality, role experience, type of experience, profile completeness or pre-employment data of the candidate.

According to yet another embodiment, the compatibility quality score reflects at least one of an ability of the candidate to perform the job role, one or more competencies, a suitability of the candidate for the job role, a performance of the candidate in the job role, or a social and behavioural parameter associated with the at least one candidate.

According to yet another embodiment, the selection of the at least one candidate is performed using a matching framework, wherein the matching framework is configured to determine non-linear relationships among the variables in the set of variables, and wherein the matching framework is configured to optimize contract completion.

According to yet another embodiment, the matching framework is based on machine learning. In an embodiment, the machine learning may be Linear Regression, Logistic Regression, Decision Tree Random forest, etc. In an embodiment, the matching framework is based on deep learning. In an embodiment, the deep learning may be Multilayer Perceptron Neural Network, Convolutional Neural Network, Recurrent Neural Network, Long Short-Term Memory, Generative Adversarial Network, Restricted Boltzmann Machine, Deep Belief Network, etc.

According to yet another embodiment, applying the hypothesis based on the at least one mathematical predictor comprises:

dynamically generating at least one cluster of candidates working on one or more similar assignments;

comparing and evaluating the at least one cluster of candidates;

applying a simple hypothesis corresponding to each of the set of variables as a proxy for each of the at least one cluster of candidates through the plurality of mathematical predictors, and combining an outcome of each of the plurality of mathematical predictors to generate a combined hypothesis;

aggregating the combined hypothesis corresponding to each of the at least one cluster of candidates as a weighted average with a dynamic weighting, to remove bias, wherein the hypothesis that is associated with a lowest significance in the particular cluster is given a lower weight, and wherein the aggregation enables maximizing of information that are extracted from a complete set;

evaluating the combined hypothesis by comparing a result of the combined hypothesis with a predetermined feedback to generate an evaluated hypothesis; and

combining the evaluated hypothesis with one or more previously evaluated hypothesis and evaluating an outcome of the results with one or more meaningful workforce outcomes.

According to yet another embodiment, the one or more similar assignments comprise assignments from a common employer, assignments from the common employer on a common site, and assignments from the common employer on the common site and on a common shift, depending on a volume of data available at a given time.

According to yet another embodiment, the hypothesis that carry more significance in a particular cluster is given a higher weight.

According to yet another embodiment, the compatibility quality score is a weighted average of the aggregated scores generated from the plurality of mathematical predictors applied to different hypothesis.

According to yet another embodiment, the method comprises applying the plurality of mathematical predictors to each hypothesis.

According to yet another embodiment, the plurality of mathematical predictors comprises at least one of: a Quantile-based scoring system, a Uniform-separation scoring system or a Clustering-based scoring system.

In an embodiment, the clustering-based scoring system employs an automated clustering algorithm. The clustering algorithm comprises at least one of a centroid-based clustering, connectivity-based clustering, or density-based clustering that groups or categorizes the user input into pre-defined clusters based on a similarity between user inputs.

According to yet another embodiment, the compatibility quality score is a weighted average of the aggregated compatibility quality scores determined using the plurality of mathematical predictors applied to a plurality of hypothesis.

According to yet another embodiment, the compatibility quality score is determined based on an employment data of the candidate from one or more other job functions and a plurality of predicted data points for a function that the candidate is not experienced with.

According to yet another embodiment, the compatibility quality score is calculated for completely new candidates based on a plurality of predicted data points.

According to yet another embodiment, the set of variables comprises at least one online variable associated with the candidate.

According to yet another embodiment, the compatibility quality score is analysed among workers for at least one of a same company, a job-function or a province to reduce context bias.

According to yet another embodiment, the compatibility quality score is calculated based on at least one of an employment data or the hypothesis that is made on the employment data using a decision tree model. In an embodiment, the compatibility quality score is analysed among candidates for at least one of a same company, a job-function or a province to reduce context bias.

According to a second aspect, there is provided a system for automatically determining a compatibility quality score for selecting at least one candidate from among a plurality of candidates suitable for a job role, using a machine learning model, to ensure a high production rate and to maintain safety standards, the system comprising:

a memory that stores a set of instructions and an information associated with a machine learning algorithm;

a processor that executes the set of instructions, for performing the steps comprising:
a candidate information receiving module implemented by the processor and configured to receive a candidate information via a communication device of at least one candidate, wherein the candidate information comprises at least one of personal information, an information regarding a specific job assignment, or an input associated with a recruitment process, associated with the at least one candidate; and
a compatibility quality score determining module implemented by the processor and configured to automatically determine, the compatibility quality score for the candidate based on the candidate information and a set of variables, for each of the plurality of candidates for the job role, and wherein the compatibility quality score is determined by applying a hypothesis through at least one mathematical predictor from among a plurality of mathematical predictors.

According to an embodiment, the system comprises a candidate selecting module that is implemented by the processor and configured to automatically select the at least one candidate from among the plurality of candidates with highest competence and suitability for the job role based on the compatibility quality score, thereby enabling achievement of a higher safety standard and a higher production rate and quality.

The present disclosure provides a computer program product comprising instructions to cause the above system to carry out the above method.

The advantages of the present system and/or computer program product are thus identical to those disclosed above in connection with the present method and the embodiments listed above in connection with the method apply mutatis mutandis to the system and/or computer program product.

Embodiments of the present disclosure optionally reduce the administrative burden associated with selecting suitable candidates for the job role. Embodiments of the present disclosure optionally reduce the time for selecting a suitable candidate for the job role. Embodiments of the present disclosure optionally enable automatic determination of compatibility quality score for each of the plurality of candidates for selecting suitable candidates for the job role.

### DETAILED DESCRIPTION OF THE DRAWINGS

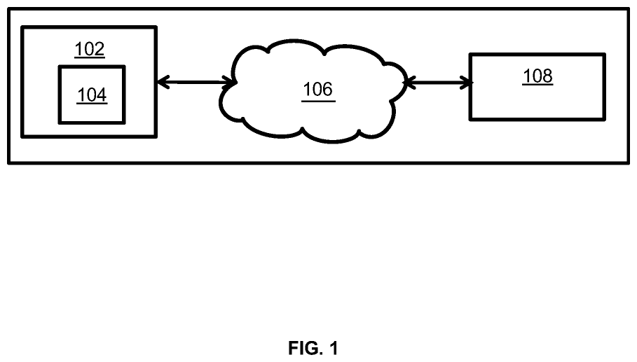

FIG. 1 is a schematic illustration of a system in accordance with an embodiment of the present disclosure. The system 102 comprises a processor 104 that is connected, when in operation, via a network 106 to a communication device 108. The functions of these parts are as described above. In an embodiment, the system 102 comprises an input interface that is connected with the communication device 108 for receiving candidate information. In an embodiment, the system 102 comprises an output interface that suggests at least one suitable candidate among a plurality of candidates for a job role.

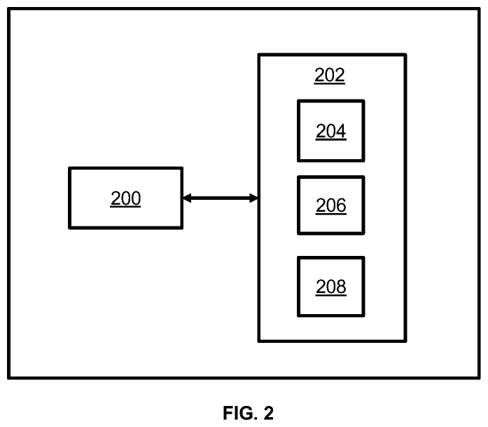

FIG. 2 is a functional block diagram of a system in accordance with an embodiment of the present disclosure. The functional block diagram of the system comprises a memory 200 and a processor 202. The processor 202 includes a candidate information receiving module 204, a compatibility quality score determining module 206, and a candidate selecting module 208. The functions of these modules are as described above.

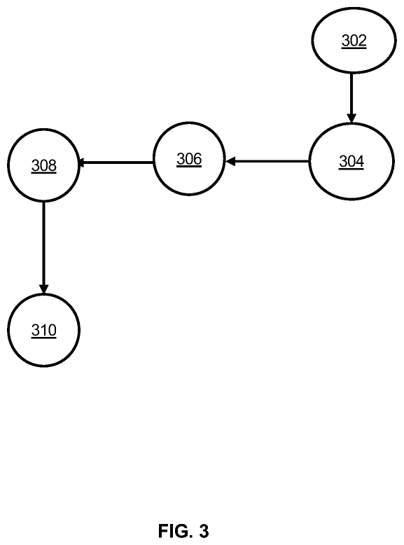

FIG. 3 is a flowchart illustrating a process flow for applying hypothesis based on at least one mathematical predictor using a system in accordance with an embodiment of the present disclosure. At a step 302, at least one cluster of candidates working on one or more similar assignments is generated to compare and evaluate the at least one cluster of candidates. At a step 304, a simple hypothesis is applied corresponding to each of a set of variables as a proxy for each of the at least one cluster of candidates through the plurality of mathematical predictors to generate a combined hypothesis. At a step 306, the combined hypothesis corresponding to each of the at least one cluster of candidates is aggregated as a weighted average with a dynamic weighting to remove bias. In an embodiment, the aggregation enables maximizing of information that is extracted form a complete set. At a step 308, the combined hypothesis is evaluated by comparing a result of the combined hypothesis with a predetermined feedback to generate an evaluated hypothesis. At a step 310, the evaluated hypothesis is combined with one or more previously evaluated hypotheses and evaluates an outcome of the results with one or more meaningful workforce outcomes.

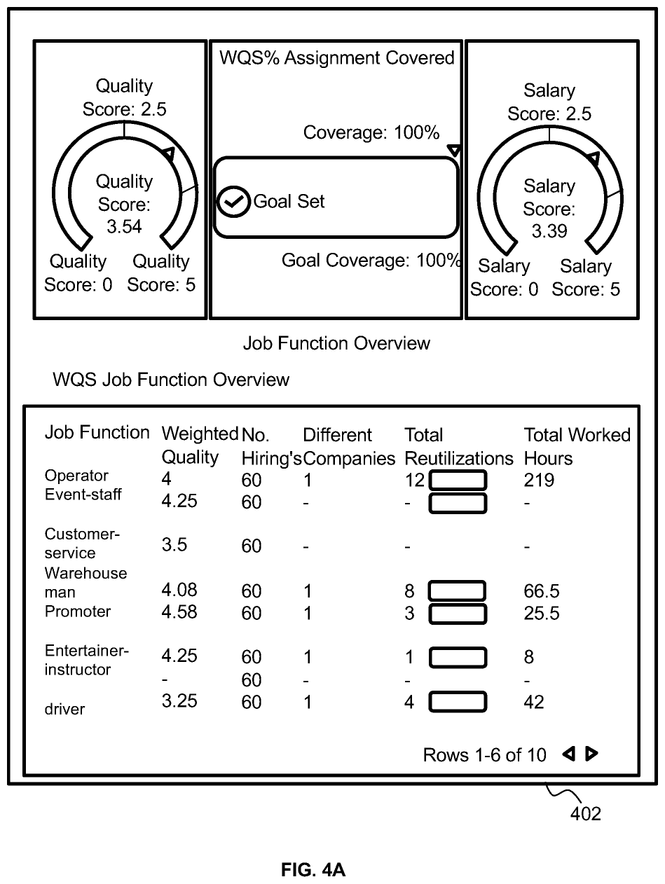

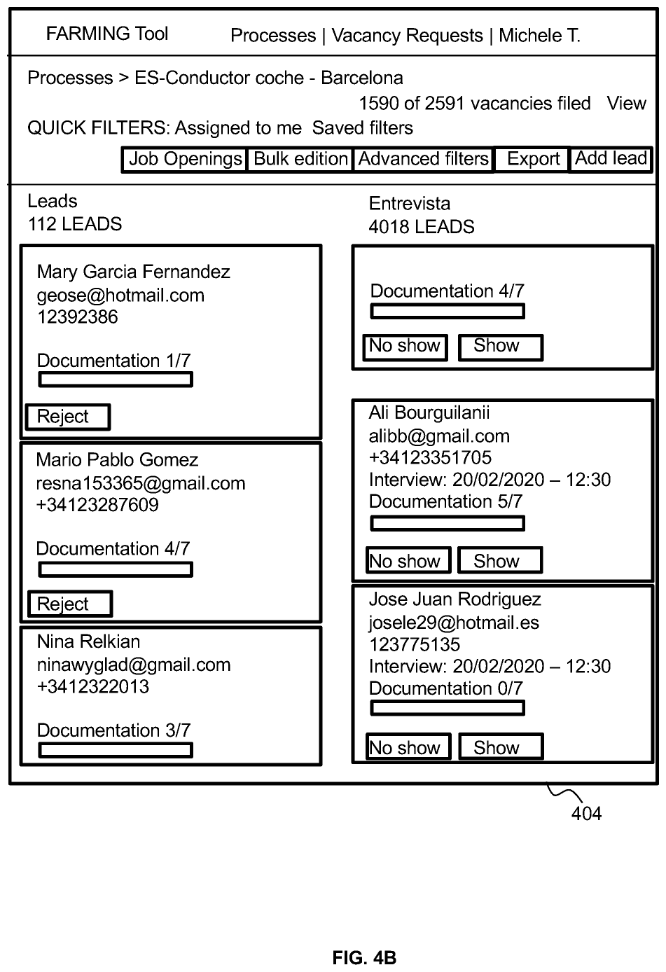

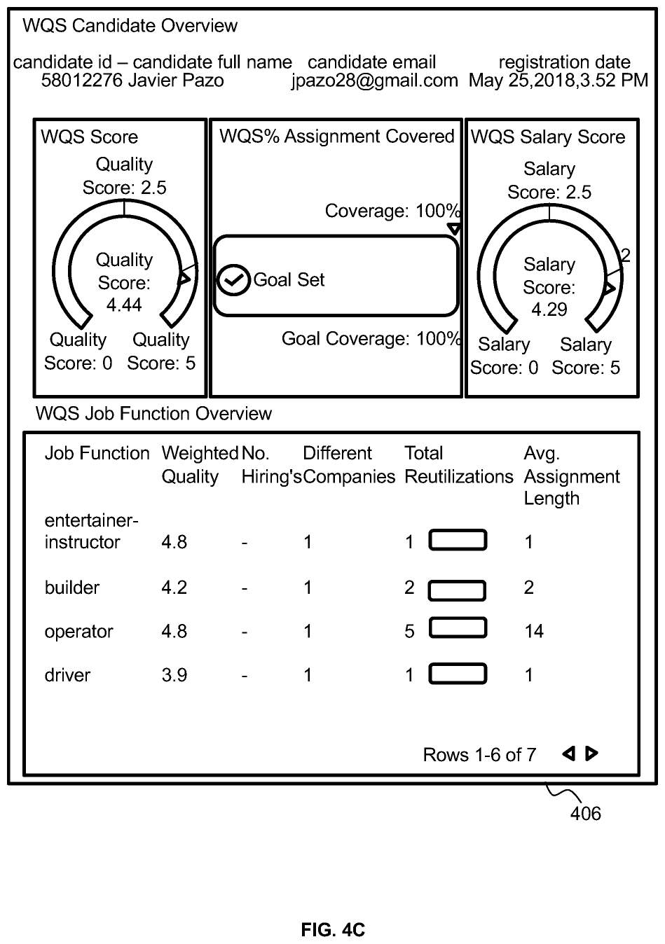

FIGS. 4A-4C are user interface views of a system, in accordance with an embodiment of the present disclosure. In FIG. 4A, a user interface 402 depicts a dashboard of a profile of at least one candidate. In an embodiment, the dashboard comprises a quality score, a salary score and a job function overview of each of the plurality of candidates. When a user selects the profile of at least one candidate among a plurality of candidates, the user interface 402 depicts the profile of that at least one candidate including a quality score of the candidate, salary score of the candidate and the job function overview of the candidate along with specific job functions and weighted quality.

In FIG. 4B, a user interface 404 depicts an internal farming tool to rank and forward the best profile of at least one candidate from a plurality of candidates. In an embodiment, the internal farming tool is a recruitment process funnel that shows the best profiles from the plurality of candidates using a worker quality score and a cold-start worker quality score. The internal farming tool shows leads for a particular job role and forwards the best profile of at least one candidate from a plurality of candidates along with the documentation of the candidates. In an embodiment, the user may reject the profile of at least one candidate from the forwarded profiles.

In FIG. 4C, a user interface 406 depicts a job-function worker quality score of each of a plurality of candidates. In an embodiment, the job-function worker quality score determines the worker quality score for the different candidates from the plurality of candidates that covers multiple job functions. In an embodiment, the job-function worker quality score is determined using a prediction method. The user interface 406 depicts a candidate ID, a candidate name, a candidate email, a registration date, a quality score, a salary score and different job-functions along with a determined weighted score of at least one candidate selected by a user.

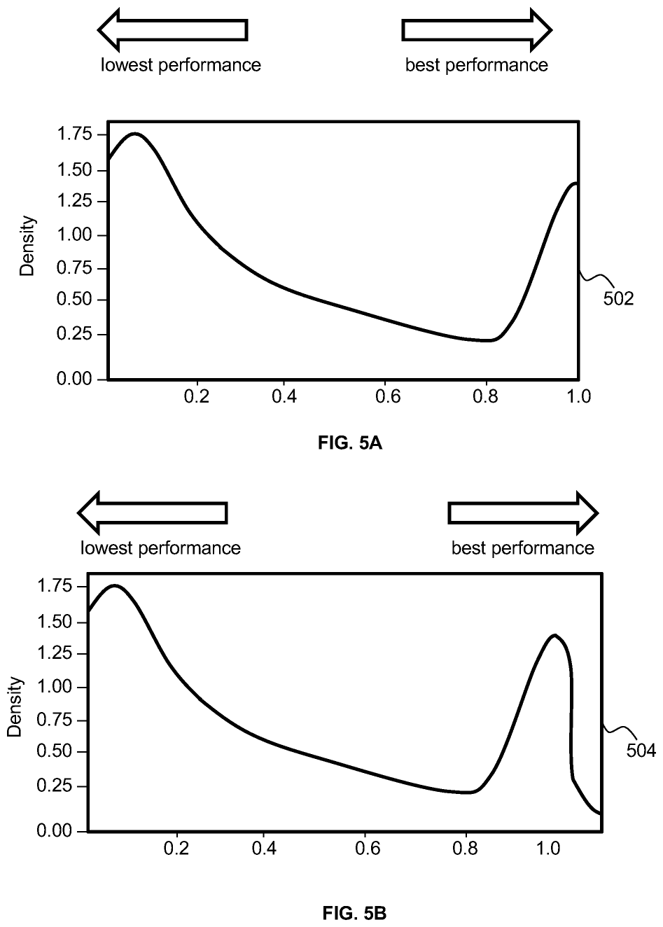

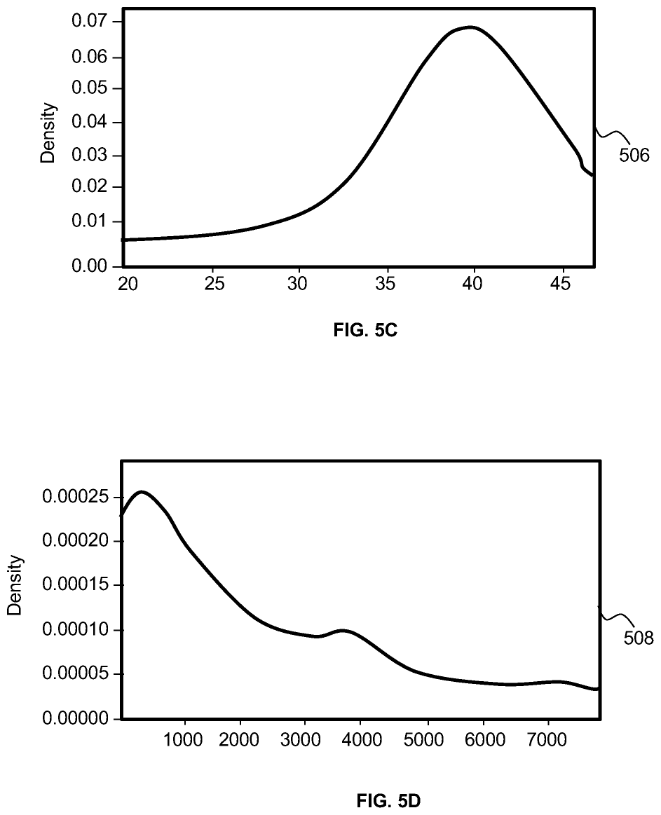

FIGS. 5A-5D illustrate graphs that depict a quality score of each of a plurality of candidates, in accordance with an embodiment of the present disclosure. In an embodiment, a hypothesis is converted into indicators with an attrition which is a percentage of contract fulfillment. The graphs comprise 1 star, 2 stars, 3 stars, 4 stars and 5 stars. In an embodiment, the 1 star is for the lowest performance and the 5 stars for best performance. In FIG. 5A, a graph 502 depicts data distribution of a uniform-separation scoring system and a clustering-based scoring system. The uniform-separation scoring system calculates a score distribution per job function and company group in order to categorize a concept of quality in buckets e.g., using quantiles. In an embodiment, the uniform-separation scoring system works also for very skewed distribution. The clustering-based scoring system works by calculating a Kmeans Cluster with a number of clusters (K) equal to a number of bins. In an embodiment, the clustering is an unsupervised machine learning technique that allows grouping of values by optimizing the position of the K clusters automatically. In an embodiment, the clustering minimizes an overall distance within all values assigned by proximity.

In FIG. 5B, a graph 504 depicts data distribution of a quantile-based scoring system. The quantile-based scoring system calculates score distribution per job function and a company group in order to categorize the concept of quality in the buckets e.g., using the quantiles. In an embodiment, if the candidates have 80^{th} percentile, the quantile-based scoring system determines 80% of the candidates are worse than other candidates. In this example embodiment of graph 504, above 1.0 means that the candidates do more than 100% of the initial contract in average (i.e. doing extra hours). In an embodiment, the predictors from the graphs 502 and 504, calculate the score from different points of views, and captures slightly different information from same statistical distribution. In an embodiment, aggregation of predictors includes a bagging method that calculates an average of predictions relying on an ensemble paradigm. In an embodiment, the aggregation of the predictors decreases a variance and increase an accuracy. In an embodiment, a score that is calculated from the average coverage percentage (%) reflects the reliability and performance of the candidate in fulfilling the vacancy as shown in the graph 504. In an embodiment, some vacancies have variables remuneration based on performance metrics (e.g. delivery per hour).

The score calculated from the estimated hourly salary reflects the performance metrics as shown in a graph 506 of FIG. 5C. In an embodiment, time taken to create and fill a profile registration and an interview process to fulfill requirements (i.e. uploading of documentation, signing of a contract, etc.) is a great proxy for interest and efficiency as shown in 508 of FIG. 5D. The quality score is determined by each score calculated from the hypothesis graphs of 504, 506 and 508 of FIGS. 5B-5D using the formula. In an embodiment, the quality score is a weighted average of the scores calculated from the different hypotheses.

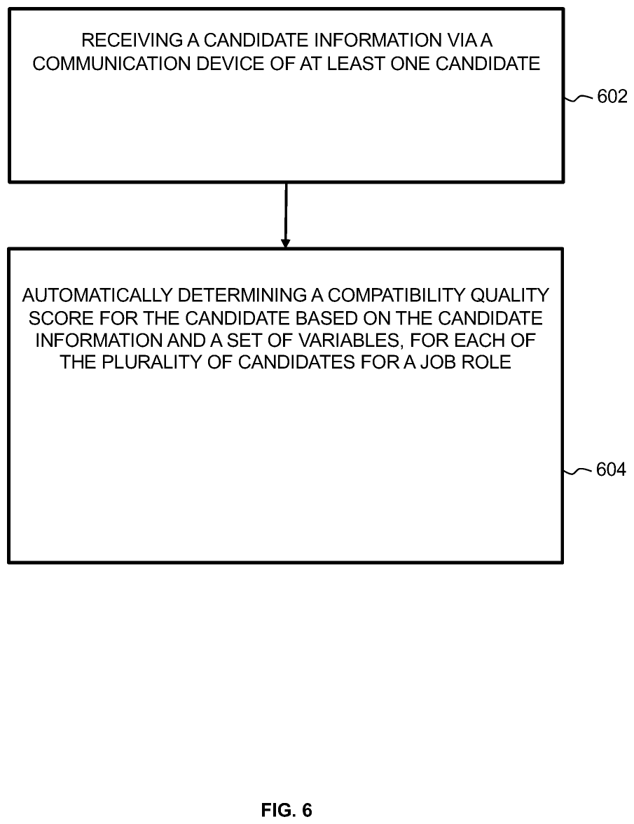

FIG. 6 is a flowchart illustrating steps of a method for (of) automatically determining a compatibility quality score for selecting at least one candidate from among a plurality of candidates suitable for a job role, in accordance with an embodiment of the present disclosure. At a step 602 of the method of automatically determining a compatibility quality score, a candidate information of the at least one candidate is received via a communication device. At a step 604 of the method of automatically determining a compatibility quality score, a compatibility quality score for the candidate is automatically determined based on the candidate information and a set of variables for selecting at least one candidate suitable for the job role. In an embodiment, the at least one candidate from among the plurality of candidates with a highest competence and suitability for the job role is automatically selected based on the compatibility quality score.

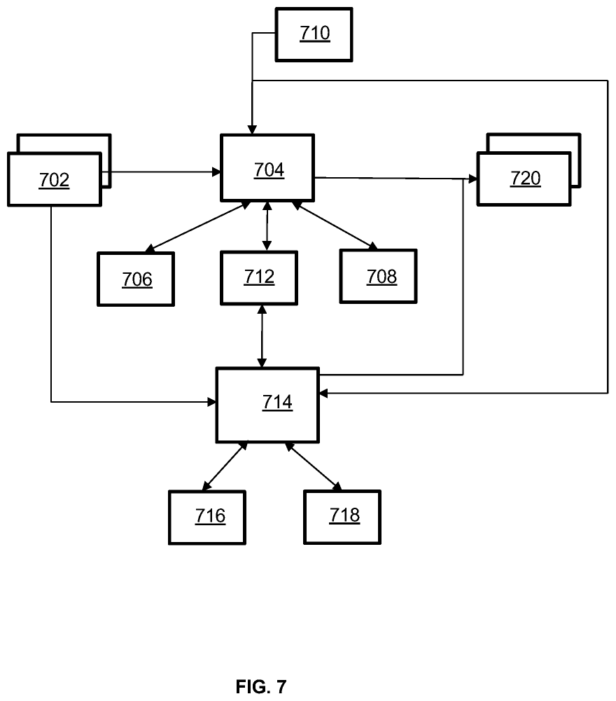

FIG. 7 is an illustration of an exploded view of a computing architecture/system in accordance with an embodiment of the present disclosure. The exploded view comprises a system that comprises an user interface 702, a control module that comprises a processor 704, a memory 706 and a non-volatile storage 708, processing instructions 710, a shared/distributed storage 712, and a communication device that comprises a processor 714, a memory 716 and a non-volatile storage 718 and an output interface 720. The function of the processor 704, the memory 706 are as described above.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of automatically determining a compatibility quality score for selecting at least one candidate from among a plurality of candidates suitable for a job role, using a machine learning model, the method comprising:
receiving a candidate information via a communication device of at least one candidate, wherein the candidate information comprises at least one of personal information, an information regarding a specific job assignment, or an input associated with a recruitment process, associated with the at least one candidate; and
automatically determining a compatibility quality score for the candidate based on the candidate information and a set of variables, for each of the plurality of candidates for the job role, and wherein the compatibility quality score is determined by applying a hypothesis through at least one mathematical predictor from among a plurality of mathematical predictors.

2. The method according to claim 1, wherein applying the hypothesis based on the at least one mathematical predictor comprises:
dynamically generating at least one cluster of candidates working on one or more similar assignments;
comparing and evaluating the at least one cluster of candidates;
applying a simple hypothesis corresponding to each of the set of variables as a proxy for each of the at least one cluster of candidates through the plurality of mathematical predictors, and combining an outcome of each of the plurality of mathematical predictors to generate a combined hypothesis;
aggregating the combined hypothesis corresponding to each of the at least one cluster of candidates as a weighted average with a dynamic weighting, to remove bias, wherein the hypothesis that is associated with a lowest significance in the particular cluster is given a lower weight, wherein the aggregation enables maximizing of information that is extracted from a complete set;
evaluating the combined hypothesis by comparing a result of the combined hypothesis with a predetermined feedback to generate an evaluated hypothesis; and
combining the evaluated hypothesis with one or more previously evaluated hypothesis and evaluating an outcome of the results with one or more meaningful workforce outcomes.

3. The method according to claim 2, wherein the one or more similar assignments comprise assignments from a common employer, assignments from the common employer on a common site, and assignments from the common employer on the common site and on a common shift, depending on a volume of data available at a given time.

4. The method according to claim 3, wherein the hypothesis that carry more significance in a particular cluster is given a higher weight.

5. The method according to claim 1, wherein the compatibility quality score is a weighted average of the aggregated scores generated from the plurality of mathematical predictors applied to different hypothesis.

6. The method according to claim 1, further comprising: applying the plurality of mathematical predictors to each hypothesis.

7. The method according to claim 1, wherein the compatibility quality score is a weighted average of the aggregated compatibility quality scores determined using the plurality of mathematical predictors applied to a plurality of hypothesis.

8. The method according to claim 1, wherein the compatibility quality score is calculated based on at least one of an employment data or the hypothesis that is made on the employment data using a decision tree model.

9. A system for automatically determining a compatibility quality score for selecting at least one candidate from among a plurality of candidates suitable for a job role, using a machine learning model, to ensure a high production rate and to maintain safety standards, the system comprising:
a memory (200) that stores a set of instructions and an information associated with a machine learning algorithm;
a processor (202) that executes the set of instructions via a plurality of modules, for performing the steps comprising:
a candidate information receiving module (204) implemented by the processor (202) and configured to receive a candidate information via a communication device of at least one candidate, wherein the candidate information comprises at least one of personal information, an information regarding a specific job assignment, or an input associated with a recruitment process, associated with the at least one candidate; and
a compatibility quality score determining module (206) implemented by the processor (202) and configured to automatically determine the compatibility quality score for the candidate based on the candidate information and a set of variables, for each of the plurality of candidates for the job role, and wherein the compatibility quality score is determined by applying a hypothesis through at least one mathematical predictor from among a plurality of mathematical predictors.
